(19) United States
(12) Patent Application Publication
(10) Pub. No.: US 2025/0212292 A1
(43) Pub. Date: Jun. 26, 2025

(54) METHOD, APPARATUS AND COMPUTER PROGRAM

(71) Applicant: Nokia Technologies Oy, Espoo (FI)

(72) Inventors: Hannu Petri HIETALAHTI, Oulu (FI); Bruno LANDAIS, Lannion (FR); Georgios GKELLAS, Athens (GR); Karim MORSY, Munich (DE); Laurent THIÉBAUT, Massy (FR); Saubhagya BALIARSINGH, Bangalore (IN)

(21) Appl. No.: 18/960,797

(22) Filed: Nov. 26, 2024

(30) Foreign Application Priority Data
Dec. 20, 2023 (IN) 202311087201

(51) Int. Cl. H04W 28/14; H04W 60/02; H04W 84/06

(52) U.S. Cl. CPC H04W 76/28; H04W 60/02; H04W 84/06

(57) ABSTRACT

A non-terrestrial core network entity is provided. The non-terrestrial core network entity comprises: receiving data from a user equipment, wherein the data comprises Control Plane (CP) data or Non-Internet Protocol Delivery (NIDD) data; buffering the data during a time period in which the non-terrestrial core network entity is not connected to a terrestrial core network entity; when the non-terrestrial core network entity is connected to the terrestrial network entity, sending the data to the terrestrial core network entity.

### TECHNICAL FIELD

Various example embodiments of this disclosure relate to a method, apparatus, system and computer program for a communications network. Some examples can be used to send information in communication networks comprising satellites that have discontinuous connectivity to a ground station.

### BACKGROUND

A communication network can be seen as a facility that enables communications between two or more communication devices, or provides communication devices access to a data network. A mobile or wireless communication network is one example of a communication network. A communication device may be provided with a service by an application server.

Such communication networks operate in according with standards such as those provided by 3GPP (Third Generation Partnership Project) or ETSI (European Telecommunications Standards Institute). Examples of standards are the so-called 5G (5th Generation) standards provided by 3GPP.

### SUMMARY

Some example embodiments of this disclosure will be described with respect to certain aspects. These aspects are not intended to indicate key or essential features of the embodiments of this disclosure, nor are they intended to be used to limit the scope of thereof. Other features, aspects, and elements will be readily apparent to a person skilled in the art in view of this disclosure.

According to a first aspect, there is provided a non-terrestrial core network entity. The non-terrestrial core network entity comprises means for: receiving data from a user equipment, wherein the data comprises Control Plane (CP) data or Non-Internet Protocol Delivery (NIDD) data; buffering the data during a time period in which the non-terrestrial core network entity is not connected to a terrestrial core network entity; when the non-terrestrial core network entity is connected to the terrestrial network entity, sending the data to the terrestrial core network entity.

According to some examples of the first aspect, the buffering comprises: buffering the data when user equipment context for the user equipment comprises an indication that the non-terrestrial core network entity is to store and forward data received from the user equipment.

According to some examples of the first aspect, the non-terrestrial core network entity is configured to perform at least: detecting the indication based on at least one of configuration of the non-terrestrial core network entity, subscriber information for a subscriber associated with the equipment, location information for the apparatus and an access and mobility policy; storing, at the non-terrestrial core network entity, the indication in the user equipment context.

According to some examples of the first aspect, the means is further for: determining a periodic update timer value for the user equipment for at least one of a periodic registration update and a tracking area update, wherein when the indication is present in the context information for the user equipment, the periodic update timer value is increased relative to when the indication is not present in the context information for the user equipment.

According to some examples of the first aspect, the means is further for: determining a user equipment reachability of the user equipment based on the presence of the indication in the user equipment context, wherein when the indication is present in the user equipment context the user equipment is determined as reachable via a store-and-forward operation.

According to some examples of the first aspect, the means is further for: determining a timer value for the user equipment for detaching from a network when not connected to the terrestrial network function, wherein when the indication is present in the context information for the user equipment, the timer value is increased relative to when the indication is not present in the context information for the user equipment.

According to some examples of the first aspect, the means is further for: sending, in response to receiving the data from the user equipment, an acknowledgement message to the user equipment, wherein the acknowledgement message comprises a Non-Access-Stratum protocol message.

According to some examples of the first aspect, the data sent to the terrestrial core network entity is secured in a Non-Access-Stratum container, wherein the terrestrial core network entity is configured to decipher the Non-Access-Stratum container using a security context of the user equipment.

According to some examples of the first aspect, the non-terrestrial core network entity comprises an access and mobility management function (AMF) and the terrestrial core network entity comprises an AMF.

According to some examples of the first aspect, the non-terrestrial core network entity comprises a Mobility Management Entity (MME) and the terrestrial core network entity comprises an MME.

According to a second aspect, there is provided an apparatus for satellite of a non-terrestrial network, the apparatus comprising: at least one processor; and at least one memory storing instructions that, when executed by the at least one processor, cause the apparatus at least to: receive data from a user equipment, wherein the data comprises Control Plane (CP) data or Non-Internet Protocol Delivery (NIDD) data; buffer the data during a time period in which a non-terrestrial core network entity at the satellite is not connected to a terrestrial core network entity; when the non-terrestrial core network entity is connected to the terrestrial network entity, send the data from the satellite to the terrestrial core network entity

According to some examples of the second aspect, the buffering comprises: buffering the data when user equipment context for the user equipment comprises an indication that the non-terrestrial core network entity is to store and forward data received from the user equipment.

According to some examples of the second aspect, the instructions when executed by the at least one processor further cause the apparatus to: detect the indication based on at least one of configuration of the non-terrestrial core network entity, subscriber information for a subscriber associated with the equipment, location information for the apparatus and an access and mobility policy; store, at the non-terrestrial core network entity, the indication in the user equipment context.

According to some examples of the second aspect, the instructions when executed by the at least one processor further cause the apparatus to: determine a periodic update timer value for the user equipment for at least one of a periodic registration update and a tracking area update, wherein when the indication is present in the context information for the user equipment, the periodic update timer value is increased relative to when the indication is not present in the context information for the user equipment.

According to some examples of the second aspect, the instructions when executed by the at least one processor further cause the apparatus to: determine, at the satellite, a user equipment reachability of the user equipment based on the presence of the indication in the user equipment context, wherein when the indication is present in the user equipment context the user equipment is determined as reachable via a store-and-forward operation.

According to some examples of the second aspect, the instructions when executed by the at least one processor further cause the apparatus to: determine, at the satellite, a timer value for the user equipment for detaching from a network when not connected to the terrestrial network function, wherein when the indication is present in the context information for the user equipment, the timer value is increased relative to when the indication is not present in the context information for the user equipment.

According to some examples of the second aspect, the instructions when executed by the at least one processor further cause the apparatus to: send, in response to receiving the data from the user equipment, an acknowledgement message to the user equipment, wherein the acknowledgement message comprises a Non-Access-Stratum protocol message.

According to some examples of the second aspect, the data sent to the terrestrial core network entity is secured in a Non-Access-Stratum container, wherein the terrestrial core network entity is configured to decipher the Non-Access-Stratum container using a security context of the user equipment.

According to some examples of the second aspect, the non-terrestrial core network entity comprises an access and mobility management function (AMF) and the terrestrial core network entity comprises an AMF.

According to some examples of the second aspect, the non-terrestrial core network entity comprises a Mobility Management Entity (MME) and the terrestrial core network entity comprises an MME.

According to a third, there is provided a method comprising: receiving, at a satellite, data from a user equipment, wherein the data comprises Control Plane (CP) data or Non-Internet Protocol Delivery (NIDD) data; buffering, at the satellite, the data during a time period in which a non-terrestrial core network entity at the satellite is not connected to a terrestrial core network entity; when the non-terrestrial core network entity is connected to the terrestrial network entity, sending the data from the satellite to the terrestrial core network entity.

According to some examples of the third aspect, the buffering comprises: buffering the data when user equipment context for the user equipment comprises an indication that the non-terrestrial core network entity is to store and forward data received from the user equipment.

According to some examples of the third aspect, the method comprises: detecting the indication based on at least one of configuration of the non-terrestrial core network entity, subscriber information for a subscriber associated with the equipment, location information for the apparatus and an access and mobility policy; storing, at the non-terrestrial core network entity, the indication in the user equipment context.

According to some examples of the third aspect, the method comprises: determining, at the satellite, a periodic update timer value for the user equipment for at least one of a periodic registration update and a tracking area update, wherein when the indication is present in the context information for the user equipment, the periodic update timer value is increased relative to when the indication is not present in the context information for the user equipment.

According to some examples of the third aspect, the method comprises: determining, at the satellite, a user equipment reachability of the user equipment based on the presence of the indication in the user equipment context, wherein when the indication is present in the user equipment context the user equipment is determined as reachable via a store-and-forward operation.

According to some examples of the third aspect, the method comprises: determining, at the satellite, a timer value for the user equipment for detaching from a network when not connected to the terrestrial network function, wherein when the indication is present in the context information for the user equipment, the timer value is increased relative to when the indication is not present in the context information for the user equipment.

According to some examples of the third aspect, the method comprises: sending, in response to receiving the data from the user equipment, an acknowledgement message to the user equipment, wherein the acknowledgement message comprises a Non-Access-Stratum protocol message.

According to some examples of the third aspect, the data sent to the terrestrial core network entity is secured in a Non-Access-Stratum container, wherein the terrestrial core network entity is configured to decipher the Non-Access-Stratum container using a security context of the user equipment.

According to some examples of the third aspect, the non-terrestrial core network entity comprises an access and mobility management function (AMF) and the terrestrial core network entity comprises an AMF.

According to some examples of the third aspect, the non-terrestrial core network entity comprises a Mobility Management Entity (MME) and the terrestrial core network entity comprises an MME.

According to a fourth, there is provided a computer readable medium comprising instructions which, when executed by an apparatus (e.g., computing device or computing system), cause the apparatus (e.g., computing device or computing system) to perform at least the following: receiving data from a user equipment, wherein the data comprises Control Plane (CP) data or Non-Internet Protocol Delivery (NIDD) data; buffering the data during a time period in which a non-terrestrial core network entity is not connected to a terrestrial core network entity; when the non-terrestrial core network entity is connected to the terrestrial network entity, sending the data to the terrestrial core network entity.

According to a fifth aspect, there is provided a terrestrial core network entity of a non-terrestrial network, the terrestrial core network entity comprising means for: connecting to a non-terrestrial core network entity; after connecting to the non-terrestrial core network entity, receiving data from the non-terrestrial core network entity that was buffered at the non-terrestrial core network entity during a time period in which the apparatus was not connected to the non-terrestrial core network entity, wherein the data was received at the non-terrestrial core network entity from a user equipment, and wherein the data comprises Control Plane (CP) data or Non-Internet Protocol Delivery (NIDD) data.

According to some examples of the fifth aspect, the means is further for: receiving, from a network entity and at a first time, second data for sending to the user equipment; determining that a second non-terrestrial core network entity will be configured to connect to the user equipment and the apparatus at a second time, wherein the second time is after the first time; buffering the second data at the apparatus until the second time; at or after the second time and while the second non-terrestrial core network entity is connected to the user equipment and the apparatus, sending the second data to the second non-terrestrial core network entity.

According to some examples of the fifth aspect, the means is further for: performing the buffering the second data when an indication is present in a user equipment context for the user equipment.

According to some examples of the fifth aspect, the means is further for: detecting the indication based on at least one of configuration of the apparatus, subscriber information for the apparatus, location information for the apparatus and an access and mobility policy for the apparatus; storing the indication in the user equipment context for the user equipment.

According to some examples of the fifth aspect, the means is further for: determining a periodic update timer value for the user equipment for at least one of a periodic registration update and a tracking area update, wherein when the indication is present in the user equipment context for the user equipment, the periodic update timer value is increased relative to when the indication is not present in the context information for the user equipment.

According to some examples of the fifth aspect, the means is further for: determining a timer value for the user equipment for detaching from a network when not connected to the apparatus, wherein when the indication is present in the context information for the user equipment, the timer value is increased relative to when the indication is not present in the context information for the user equipment.

According to some examples of the fifth aspect, the data received from the non-terrestrial core network entity deployed on the satellite is secured in a Non-Access-Stratum container, the terrestrial core network entity configured to perform at least: deciphering the Non-Access-Stratum container using a security context of the user equipment to determine a payload of the Non-Access-Stratum container.

According to some examples, the means is further for: sending the payload to a third the non-terrestrial core network entity with connectivity to the apparatus.

According to some examples of the fifth aspect, the non-terrestrial core network entity comprises an access and mobility management function (AMF) and the terrestrial core network entity comprises an AMF.

According to some examples of the fifth aspect, the non-terrestrial core network entity comprises a Mobility Management Entity (MME) and the terrestrial core network entity comprises an MME.

According to a sixth aspect, there is provided a terrestrial core network entity comprising at least one processor and at least one memory storing instructions that, when executed by the at least one processor, cause the terrestrial core network entity at least to: connect to a non-terrestrial core network entity; after connecting to the non-terrestrial core network entity, receive data from the non-terrestrial core network entity that was buffered at the terrestrial core network entity during a time period in which the apparatus was not connected to the non-terrestrial core network entity, wherein the data was received at the non-terrestrial core network entity from a user equipment, and wherein the data comprises Control Plane (CP) data or Non-Internet Protocol Delivery (NIDD) data

According to some examples of the sixth aspect, the instructions when executed by the at least one processor further cause the terrestrial core network entity to: receive, from a network entity and at a first time, second data for sending to the user equipment; determine that a second non-terrestrial core network entity deployed on a second satellite will be configured to connect to the user equipment and the apparatus at a second time, wherein the second time is after the first time; buffer the second data at the apparatus until the second time; at or after the second time and while the second non-terrestrial core network entity is configured to connect to the user equipment and the terrestrial core network entity, send the second data to the second non-terrestrial core network entity

According to some of the sixth aspect, the instructions when executed by the at least one processor further cause the terrestrial core network entity to: perform the buffering the second data when an indication is present in a user equipment context for the user equipment.

According to some of the sixth aspect, the instructions when executed by the at least one processor further cause: detect the indication based on at least one of configuration of the user equipment, subscriber information for the user equipment, location information for the user equipment and an access and mobility policy for the user equipment; store, at the terrestrial core network entity, the indication in the user equipment context for the user equipment

According to some examples of the sixth aspect, the instructions when executed by the at least one processor further cause the terrestrial core network entity to: determine a periodic update timer value for the user equipment for at least one of a periodic registration update and a tracking area update, wherein when the indication is present in the user equipment context for the user equipment, the periodic update timer value is increased relative to when the indication is not present in the context information for the user equipment

According to some examples of the sixth aspect, the instructions when executed by the at least one processor further cause the terrestrial core network entity to: determine a timer value for the user equipment for detaching from a network when not connected to the apparatus, wherein when the indication is present in the context information for the user equipment, the timer value is increased relative to when the indication is not present in the context information for the user equipment

According to some examples of the sixth aspect, the data received from the non-terrestrial core network entity is secured in a Non-Access-Stratum container, and the instructions, when executed by the at least one processor, further cause the terrestrial core network entity to:: decipher, at the terrestrial core network entity, the Non-Access-Stratum container using a security context of the user equipment to determine a payload of the Non-Access-Stratum container.

According to some examples of the sixth aspect, the instructions when executed by the at least one processor further cause the terrestrial core network entity to: send, from the terrestrial core network entity, the payload to a third non-terrestrial core network entity deployed on a third satellite with connectivity to the apparatus.

According to a seventh, there is provided a method comprising: connecting, by a terrestrial core network entity, to a non-terrestrial core network entity; after connecting to the non-terrestrial core network entity, receiving data from the non-terrestrial core network entity that was buffered at the terrestrial core network entity during a time period in which the terrestrial core network entity was not connected to the non-terrestrial core network entity, wherein the data was received at the non-terrestrial core network entity from a user equipment, and wherein the data comprises Control Plane (CP) data or Non-Internet Protocol Delivery (NIDD) data.

According to some examples of the seventh aspect, the method comprises: receiving, at the terrestrial core network entity, from a network entity and at a first time, second data for sending to the user equipment; determining, at the terrestrial core network entity, that a second non-terrestrial core network entity deployed on a second satellite will be configured to connect to the user equipment and the apparatus at a second time, wherein the second time is after the first time; buffering, at the terrestrial core network entity, the second data at the apparatus until the second time; at or after the second time and while the second non-terrestrial core network entity deployed on the second satellite is configured to connect to the user equipment and the apparatus, sending the second data to the second non-terrestrial core network entity.

According to some examples of the seventh aspect, the method comprises: performing the buffering the second data when an indication is present in a user equipment context for the user equipment.

According to some examples of the seventh aspect, the method comprises: detecting, at the terrestrial core network entity, the indication based on at least one of configuration of the user equipment, subscriber information for the user equipment, location information for the user equipment and an access and mobility policy for the user equipment; storing, at the terrestrial core network entity, the indication in the user equipment context for the user equipment.

According to some examples of the seventh aspect, the method comprises: determining, at the terrestrial core network entity, a periodic update timer value for the user equipment for at least one of a periodic registration update and a tracking area update, wherein when the indication is present in the user equipment context for the user equipment, the periodic update timer value is increased relative to when the indication is not present in the context information for the user equipment.

According to some examples of the seventh aspect, the method comprises: determining, at the terrestrial core network entity, a timer value for the user equipment for detaching from a network when not connected to the apparatus, wherein when the indication is present in the context information for the user equipment, the timer value is increased relative to when the indication is not present in the context information for the user equipment.

According to some examples of the seventh aspect, the data received from the non-terrestrial core network entity deployed on the satellite is secured in a Non-Access-Stratum container, the method comprising: deciphering, at the terrestrial core network entity, the Non-Access-Stratum container using a security context of the user equipment to determine a payload of the Non-Access-Stratum container.

According to some examples of the seventh aspect, the method comprises: sending, from the terrestrial core network entity, the payload to a third non-terrestrial core network entity deployed on a third satellite with connectivity to the terrestrial core network entity.

According to an eighth aspect, there is provided a computer readable medium comprising instructions which, when executed by an apparatus (e.g., a computing device or computing system), cause the apparatus (e.g., a computing device or computing system) to perform at least the following: connecting, by a terrestrial core network entity, to a non-terrestrial core network entity; after connecting to the non-terrestrial core network entity, receiving data from the non-terrestrial core network entity that was buffered at the terrestrial core network entity during a time period in which the terrestrial core network entity was not connected to the non-terrestrial core network entity, wherein the data was received at the non-terrestrial core network entity from a user equipment, and wherein the data comprises Control Plane (CP) data or Non-Internet Protocol Delivery (NIDD) data.

According to a nineth aspect, there is provided a non-transitory computer readable medium comprising program instructions that, when executed by an apparatus (e.g., a computing device or computing system), cause the apparatus (e.g., a computing device or computing system) to perform at least the method according to any of the preceding aspects.

In the above, many different embodiments have been described. It should be appreciated that further embodiments may be provided by the combination of any two or more of the embodiments described above.

### DESCRIPTION OF FIGURES

Some example embodiments will now be described, by way of non-limiting and illustrative example only, with reference to the accompanying Figures in which:

FIG. 1 shows an example non-terrestrial network;

FIG. 2 shows an example non-terrestrial network;

FIG. 3 shows an example message flow for an RRC connection establishment procedure;

FIG. 4 shows an example of a non-terrestrial network including two non-terrestrial network nodes and a terrestrial network node network during three time periods;

FIG. 5 shows an example of an example of signalling and operations that occur when a UE requests a service provided by an NTN that is configured for store and forward operations;

FIG. 6 shows example of signalling and operations that occur when a UE attaches to a NTN that is configured for store and forward operations;

FIG. 7 shows an example method performed by a non-terrestrial core network entity;

FIG. 8 shows an example method performed by a-terrestrial core network entity;

FIG. 9 shows a representation of a core network entity for the communication system of FIG. 1 or FIG. 2 according to some example embodiments;

FIG. 10 shows a representation of a communication device according to some example embodiments; and

FIG. 11 shows a schematic representation of a non-volatile memory medium storing instructions which when executed by a processor allow a processor to perform one or more of the steps of the methods disclosed herein.

### DETAILED DESCRIPTION

Non-terrestrial networks (NTNs) are wireless communication systems where at least part of the network is located above the Earth's surface. NTNs may involve satellites at low Earth orbit (LEO), medium Earth orbit (MEO) and geostationary orbit (GEO), high-altitude platforms (HAPS) and drones. Due to the high cost of satellite launch and operation, NTNs comprising satellite networks with incomplete satellite constellations are foreseen. Such satellite networks are often cost-efficient to launch and operate and can be useful for applications that are not time-critical (e.g., Internet of Things (IoT) NTN having sparse LEO or MEO constellations and a limited number of ground stations). Satellite networks with incomplete satellite connections may have discontinuous satellite connectivity with User Equipment's (UEs) and/or may have discontinuous connectivity to a ground station (e.g., ground station connectivity) due to coverage gaps that are caused by satellites that are missing from a full satellite constellation or due to a lack of ground station connectivity at some locations. A satellite network with an incomplete satellite constellation cannot be guaranteed to have ground station connectivity via a feeder link to the ground station at all times, and also cannot be guaranteed to provide continuous coverage to a UE in the satellite network (instead, only intermittent coverage may be available). A satellite may be able to establish a connection to a ground station (“a ground station connection”) for sending Control Plane (CP) data and/or signalling at certain points in the satellite's orbit, and may not be able to establish a ground station connection at other points. Similarly, the satellite may be able to establish a connection for sending CP data and/or signalling to a UE at certain points in the satellite's orbit, and may not be able to establish such a connection at other points. Consequently, in some situations a satellite may have either ground station connectivity (e.g., connectivity to a ground station via a feeder link) or satellite connectivity (e.g., connectivity to a UE via a satellite link), but not both at the same time.

In NTNs with discontinuous satellite connectivity with UEs or a ground station, using a store-and-forward operation in the NTN can be useful. When a store-and-forward operations is used in a network, downlink CP data and/or signalling can be uploaded by a ground station to the satellite, buffered at the satellite and then transferred to a UE when the satellite has travelled further on its orbit to a point where a connection to the UE can be established. This enables the next hop to the UE for the stored payload. Uplink CP data and/or signalling can be similarly buffered at the satellite when a store-and-forward operation is used in a NTN, such that the CP data and/or signalling is sent by a UE to the satellite, buffered at the satellite and then later transferred to a ground station once the satellite has travelled further on its orbit to a point where a ground station connection to the ground station can be established. This enables the next hop to the ground station for the stored payload. A ground station connection between a ground station and a satellite may be considered to be established on a “feeder link”. When a satellite does not have aground station connection, the satellite will have discontinuous connectivity to the core network (CN).

An example scenario where a satellite may provide coverage for a UE but not have a ground station connection via a feeder link at the same time may occur when a LEO or MEO satellite provides a cell that covers the UE onboard a ship in the ocean, but the satellite's ground station connection towards the other Network Function (NFs) or network entities deployed at a ground station is not available.

Procedures for Mobile Originating (MO) and Mobile Terminating (MT) data using store-and-forward operations are discussed below.

As discussed above, a NF deployed at a satellite can receive a message from a ground station, and store the message in memory (buffer the message) until the satellite establishes a connection to the UE, and then transmit the message to the UE. The NF deployed on the satellite can also be used to buffer data sent in the opposite direction from the UE to the ground station until the satellite establishes a connection to the ground station. Peer core network entities may be used to perform such store-and-forward operations. These peer core network function may comprise network functions or network entities of the core network where one is deployed in a satellite (non-terrestrial) and the other in a ground station that connects to the satellite (terrestrial). Examples of peer core network entitles are network functions configured for access and mobility management of UEs (e.g., Access and Mobility Management Functions (AMFs) of a 5GC) or a network entity configured for mobility management of UEs (e.g., a Mobility Management Entity (MME) of an Evolved Packet Core (EPC)). A non-terrestrial AMF is referred to herein as an AMF-N and a terrestrial AMF is referred to herein as an AMF-T. A non-terrestrial MME is referred to herein as MME-T, and a terrestrial MME is referred to herein as MME-T.

In examples described herein, the non-terrestrial Core Network peer entity can intelligently handle the Non-Access Stratum (NAS) protocol communication by using a capability to encode and decode NAS messages. This non-terrestrial Core Network peer entity onboard a satellite can used more advanced protocol capabilities such as NAS protocol-related security parameters, Radio Access Network (RAN) security keys and NAS message Sequence Numbers (SNs).

In the following various example embodiments are explained with reference to UEs that are capable of communication with a communication system of a communication network. In some examples, the UE may comprise an IoT device.

Examples described herein include a core network entity (e.g., AMF or an MME) that is partly deployed in a satellite. Using this deployment, a single Public Land Mobile Network (PLMN) operator can deploy this architecture in a network without impacting roaming partner PLMNs.

In some examples described herein, it is assumed that a UE is registered to a PLMN. This registration can be performed when both UE coverage and the serving AMF/MME have ground station connectivity.

In some examples, Mobile Originating (MO) and/or Mobile Terminating (MT) data can be buffered at the NF deployed at a satellite in orbit and MT data can be buffered at the NF deployed at ground station. A core network entity (e.g., AMF or MME) is split so that the peer core network entities are deployed with one peer core network entity deployed at an apparatus on the ground and one peer core network entity deployed at a satellite. The peer core network entities may detect based on a configuration of the peer core network entities that a store-and-forward operation is necessary, and can then handle data buffering (e.g., buffering of data) to enable a store-and-forward operation. In some examples, Cellular IoT (CIoT) CP data delivery is used by a User Plane Function UPF or Serving Gateway (S-GW) to send MT data (e.g., CIoT CP data) to a UE and the MT data (e.g., Clot CP data) is buffered at a satellite. In some examples, CIoT Non-IP Data Delivery (NIDD) is used to send MO data (e.g., CIoT NID) and the MO data is buffered at the satellite.

The configuration may comprise a configuration known by a core network entity (e.g., AMF or MME) that indicates that a certain cell, identified by its Cell ID, is of a particular type. The configuration may be static in come examples. Based on the configuration, the core network entity can determine that a certain Cell ID corresponds to a certain RAT Type. For example, the core network entity can determine based on the configuration that a certain cell is onboard an LEO satellite in an incomplete satellite constellation, and therefore the core network entity can determine that a store-and-forward operation is required when communicating via that cell. The same core network entity in the same PLMN may have a satellite cell on a GEO satellite where the connectivity is continuous. When the UE is accessing that GEO cell, no store-and-forward operation is determined necessary by the core network entity based on the identifier of the cell (cell ID of the cell).

In some examples, the core network entity may determine that a store-and-forward operation is necessary for a UE (e.g., should be used for a UE or apply for a UE) based on subscriber information for the UE. Subscriber information for the UE may be stored in a Unified Data Management (UDM) or Unified Data Repository (UDR) for a subscriber associated with the UE. In some examples, the subscriber information for a UE may comprise an indication that indicates that a store-and-forward operation is necessary (e.g., should be used for the UE or applies for the UE). In some examples, the core network entity may determine that a store-and-forward operation is necessary for a UE (e.g., should be used for a UE or applies for a UE) based on information included in the subscriber information for the UE. For example, the subscriber information for the UE may include information that indicates the UE is subscribed to a RAT type or a TA that comprises a satellite cell having an incomplete satellite constellation, and the core network entity may determine that a store-and-forward operation is necessary for a UE (e.g., should be used for a UE or applies for the UE) based information. Store-and-forward operation by subscription can apply, for example, for Cellular IoT (CIoT) networks where a dedicated satellite telemetry subscription would be only allowed access (by subscription) in a particular RAT Type (NR LEO, NR MEO) or in a particular set of tracking areas (TAs) that are deployed onboard a satellite.

The peer core network entities (terrestrial and non-terrestrial) used for buffering data and/or signalling may comprise peer AMFs for 5G System (5GS) or peer MMEs for Evolved Packet Systems (EPS). Herein, a core network entity deployed at a ground station is referred to as a Terrestrial core network entity. For example, an AMF deployed at a ground station is referred to as AMF-T and an MME deployed at a ground station is referred to as MME-T (“T” for Terrestrial). A corresponding core network entity deployed at a satellite is referred to as a non-terrestrial core network entity. An AMF deployed at a satellite is referred to as an AMF-N and a MME deployed at a satellite is referred to as MME-N (“N” for Non-terrestrial). The terrestrial and non-terrestrial core network entities may be considered to be “peer” core network entities.

After UE registration and related security procedures target UEs in an NTN may be under direct coverage of a satellite at least occasionally such that registration and mobility updates can be performed either via the terrestrial network or performed when the satellite has ground station connectivity. The store-and-forward procedures discussed herein can be used in some examples for transmission of CIoT CP data when a UE is served by satellite cell that at least occasionally loses its ground station connectivity. According to some examples, the CIoT CP data may be small relative to User Plane data. An indication to use a store-and-forward operation can be detected at registration, during a UE mobility update or at a periodic update time. In 5GS systems, examples disclosed herein may be used for User Plane Function (UPF) CIoT CP data transmission and/or NIDD. In EPS systems, examples disclosed herein may be used for Packet Network Data Gateway (P-GW) anchored CP data and/or NIDD.

A core network entity of peer core network entities (e.g., AMF or MME) may determine whether a store-and-forward operation applies for a UE, based on at least one of: a configuration of the core network entity (e.g., AMF or MME); subscriber information of a subscriber associated with the UE; an Access and Mobility (AM) policy; location information of the UE. If the core network entity, determines that a store-and-forward operation applies for the UE based on at least one of: a configuration of the core network entity (e.g., AMF or MME); subscriber information of a subscriber associated with the UE; an AM policy that is sent by the PCF to the AMF for each subscriber and for each RAT Type to steer the AMF processing of the UE's access and mobility parameters; location information of the UE; then the core network entity, may set a store-and-forward indication that is included in the UE context for the UE to indicate that a store-and forward operation applies for the UE. Otherwise, if the core network entity determines that the store-and-forward operation for the UE does not apply based on a configuration of the core network entity (e.g., AMF or MME); subscriber information of a subscriber associated with the UE; an Access and Mobility (AM) policy; location information of the UE, the core network entity sets the store-and-forward indication to indicate that a store-and-forward operation does not apply for the UE. Examples of AM policy are described in 3GPP TS 23.501 and TS 23.502.

If a 5GS Registration procedure is performed, the core network entity (e.g., the AMF), informs a UDM of the store-and-forward indication (e.g., provides the store-and forward indication to a UDM) during the 5GS registration. If an EPS Attach or TAU procedure is performed, a core network entity (e.g., the MME) informs a Home Subscriber Server (HSS) of the store-and-forward indication during the EPS Attach, or TAU procedure.

The AMF and the UDM (or MME and HSS) awareness of “UE reachability” can be enhanced by considering the store-and-forward indication in addition to the already specified criteria (“UE reachability”, is referred to in 3GPP TS 23.502 clause 4.15.3.1 Table 4.15.3.1-1). If the store-and-forward indication indicates that a store-and-forward operation does not apply for the UE (e.g., the store-and-forward indication has a value “NOT SET”), then the AMF and the UDM (or MME and HSS) determines UE reachability according to known methods. If store-and-forward indication indicates that a store-and-forward operation applies for the UE (e.g., the store-and-forward indication has a value “IS SET”), the AMF and the UDM (or MME and HSS) may consider the UE to be reachable (via store-and-forward operation) even if it would not be reachable according to known UE reachability criteria.

For 5GS, when the core network entity (e.g., the AMF-N) receives a registration request from a UE, the core network entity (e.g., AMF-N) accepts the registration of the UE and includes a store-and-forward indication for the UE in the REGISTRATION ACCEPT message, and sends the REGISTRATION ACCEPT message to the UE. The store-and forward indication informs the UE that an immediate end-to-end response for data and/or signalling sent from the UE is not possible. Optionally an extended NAS timer can also be indicated for store-and-forward operations. For EPS, when a MME receives an ATTACH request or TAU request from a UE, the MME includes store-and-forward indication for the UE in the ATTACH ACCEPT or TAU ACCEPT (TRACKING AREA UPDATE ACCEPT) message sent to the UE. This indicates to the UE that an immediate end-to-end response for data and/or signalling sent from the UE is not possible. Optionally an extended NAS timer can also be indicated for a store-and-forward operation for the UE.

When a terrestrial core network entity (e.g., AMF-T, MME-T) or non-terrestrial core network entity (e.g., AMF-N, MME-N) has the store-and-forward indication stored for a UE, the store-and-forward indication may be taken into account by the core network entity when determining a value of a periodic update timer for the UE (generally referred to as a periodic update timer value) to ensure that the UE does not need to perform excessively frequent periodic registration updates or TAUs. The core network entity may increase the periodic update timer value (e.g., increase the value of the periodic update timer) when the store-and-forward indication indicates that a store-and-forward operation applies for a UE relative to when the store-and-forward indication is set to indicate that a store-and-forward operation does not apply for a UE.

When a terrestrial core network entity (e.g., AMF-T, MME-T) has the store-and-forward indication and the store-and-forward indication indicates that a store-and-forward operation applies for a UE (e.g., a corresponding indicator in the UE context stored at the terrestrial core network entity has been set to a value that indicates that a store-and-forward operations applies for the UE), the terrestrial core network entity (e.g., AMF-T, MME-T) may take this into account when determining the implicit detach timer value for the UE to ensure that the UE does not get implicitly detached due to long store-and-forward delay. An implicit detach timer may comprise a timer used to measure a time period, where at the end of the time period the network detaches the UE, without notifying the UE. The implicit detach timer value may be increased when the store-and-forward indication indicates that a store-and-forward operations applies for the UE.

An example of an implicit detach timer is described as follows. A UE may leave a network by sending a de-registration request and the network responding to the request. In addition to this option, a core network entity may run an error handling procedure. When a UE re-registers, a core network entity (MME or AMF) may set a timer that is longer than the Periodic Registration Update timer that it assigns for the UE. If the UE for example runs out of battery or flies away on board a plane quickly losing coverage, the CN won't keep holding the UE registration state indefinitely. After the Periodic Update Timer on the network side expires, the core network entity may an implicit detach timer. If the implicit detach timer expires, the CN de-registers the UE locally, without any signalling. A store-and-forward operation S can increase a long delay for the UE to gain its next opportunity to perform Mobility Update or Periodic Update. If the store-and-forward operation is determined necessary, a core network entity may apply extended periodic update timer value or implicit detach timer value or both in order to avoid implicitly detaching a UE that simply could not perform its periodic update because no satellite coverage or feeder link from satellite to ground station was not available.

When a non-terrestrial core network entity (e.g., AMF-N, MME-N), has the store-and-forward indication and the store-and-forward indicator indicates that a store-and-forward operation applies for a UE (e.g., a corresponding indicator in the UE context stored at the terrestrial core network entity has been set to a value that indicates that a store-and-forward operations applies for the U), the terrestrial core network entity may take this into account when determining the detach timer value or periodic update timer for the UE to ensure that the UE does not get detached due to long store-and-forward delay. The detach timer value may be increased when the store-and-forward indication indicates that a store-and-forward operations applies for the UE.

For MO data or NIDD data, when a store-and-forward indication indicates that a store-and-forward operation applies for a UE and no ground connection is available, the non-terrestrial core network entity (e.g., AMF-N or MME-N) instance deployed at the satellite receives and can acknowledge MO CP data or NIDD data from the UE. The acknowledgement may be performed using a NAS protocol (e.g., sent by the UE in a NAS message). The non-terrestrial core network entity can buffer the MO CP data or NIDD data until the non-terrestrial core network entity regains ground station connectivity (e.g., connectivity to the ground station via the feeder link). The non-terrestrial core network entity after regaining ground station connectivity continues the sends CP data and/or NIDD data via its peer terrestrial core network entity (e.g., AMF-T, MME-T) on the ground.

For MT data or NIDD data, when store-and-forward indication indicates that a store-and-forward operation applies for the UE and the terrestrial core network entity (e.g., AMF-T, MME-T) instance on the ground cannot reach the UE directly, the terrestrial core network entity can discover peer non-terrestrial core network entity (e.g., AMF-N, MME-N) instance on board a satellite that has or will have ground station connection and is foreseen to reach the UE later on. When the terrestrial core network entity instance deployed at the apparatus of the ground station has discovered its peer non-terrestrial core network entity instance deployed at the satellite, the terrestrial core network entity transmits the CP data/NIDD data to the non-terrestrial core network entity instance deployed at the satellite when the ground station gets connectivity with the satellite. Until the satellite has connectivity with the ground station, MT data and/or signalling is buffered (e.g., stored) in the terrestrial core network entity, or alternatively, in the SMF (for 5G systems) or SGW (in 4G systems) for an extended buffer duration. When the connectivity with the satellite is available, the terrestrial core network entity triggers the MT data delivery to the non-terrestrial core network entity on the satellite. The non-terrestrial core network entity instance on the satellite can buffer the CP MT data and/or NIDD data until the target UE is in a coverage of the satellite. The non-terrestrial core network entity then transmits the MT data to the target UE. In some examples, the non-terrestrial core network entity on the satellite may only be discoverable by a terrestrial core network entity on the ground and network entities (e.g. NG-RAN node (e.g., gNB or an eNB)) deployed at the satellite.

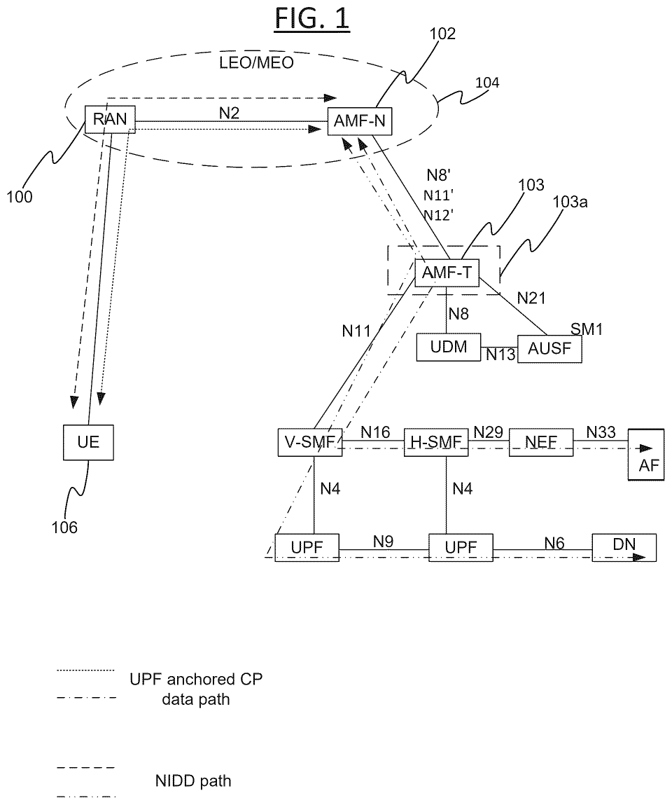

FIG. 1 shows a communication network comprising a non-terrestrial network comprising a RAN node 100 and a non-terrestrial core network entity 102 (e.g., AMF-N) 102 deployed at a satellite 104 of the NTN. According to some examples, satellite 104 of the NTN may be in LEO or MEO. Non-terrestrial core network entity 102 comprises a core network entity instance deployed at the satellite 104. According to some examples, the communication network shown in FIG. 1 can be used for transmitting CIoT CP data and/or NIDD data to a UPF anchor of a core network deployed at a ground station 103a (e.g., deployed at an apparatus of a ground stations 103a). The communications network of FIG. 1 may comprise a 5G network.

A terrestrial core network entity instance 103 (e.g., AMF-T) deployed at the ground station 103a (e.g., deployed at an apparatus of the ground station 103a) interfaces with the non-terrestrial core network entity instance 102 (e.g., AMF-N) onboard the satellite 104 (e.g., deployed at satellite 104). Terrestrial core network entity 103 may have access to satellite orbit data such that terrestrial core network entity 103 is aware of satellite coverage in terms of feeder link availability. Terrestrial core network entity 103 can support the core network entity role (e.g., AMF role) forwards other NFs on the ground. Home PLMN (H-PLMN) and virtual PLMN (V-PLMN) are shown in FIG. 1 and the core network functions of these networks are also shown. As shown in FIG. 1, NFS may include Authentication Server Function (AUSF), UDM, Virtual Session Management Function (V-SMF), Home Session Management Function (H-SMF), NEF, AF, UPF(s), Data Network (DN). In some examples ground station 103a may comprise at least one of these NFs as well as terrestrial core network entity 103. Terrestrial core network entity 103 can support an interface with satellite specific core network entity (e.g., AMF) functionality. The interface may be aware of the delay in transmission of data to/from the terrestrial core network entity 103 and the satellite specific core network entity. Non-terrestrial core network entity 102 on board satellite 104 can pick CP data or NIDD data and carry it to UE 106 without having feeder link at message delivery time, the feeder link comprising the link between non-terrestrial core network entity 102 and terrestrial core network entity 103.

The core network entity (non-terrestrial core network entity 102 (e.g., an AMF-N) and/or terrestrial core network entity 103 (e.g., an AMF-T) can store a “store-and-forward” indication in context information for UE 106 at UE registration time when the UE initiates registration procedure (e.g., when a UE registers with the core network). Non-Terrestrial core network entity 102 can indicate via terrestrial core network entity 103 to UDM that the non-terrestrial core network entity 102 uses a store-and-forward operation. Terrestrial core network entity 103 can determine the next core network entity (e.g., next AMF-N 102) that can reach UE 106. Terrestrial core network entity 103 can send CP data or NIDD data towards non-terrestrial core network entity 102 when a feeder link between non-terrestrial core network entity 102 and terrestrial core network entity 103 exists. Non-terrestrial core network entity 102 sends the CP data or NIDD data to UE 106 when UE 106 is in a coverage area of satellite 104.

According to some examples, UE 106 is registered to the core network of FIG. 1 when the non-terrestrial core network entity 102, terrestrial core network entity 103 and UE 106 are connected. Non-terrestrial core network entity 102 and terrestrial core network entity103 may detect a need to support store-and-forward operation e.g., when the UE registers with the core network.

According to some examples, non-terrestrial core network entity 102 may have a storage capacity to store the message (e.g., CIoT CP data, NIDD data or Short Message Service (SMS) data) it transmits between UE 106 and terrestrial core network entity 103. According to some examples, non-terrestrial core network entity 102 may have a storage capacity sufficient to store control plane small data. In some examples, non-terrestrial core network entity 102 may have security parameters needed for NAS procedure. NAS security may terminate in terrestrial core network entity103 or in the non-terrestrial core network entity 102. When NAS security terminates in non-terrestrial core network entity 102, the non-terrestrial core network entity can use the security parameters and the message sequence numbers that are required to encode a NAS message.

The store-and-forward operation performed at non-terrestrial core network entity 102 or terrestrial core network entity103 may be steered by the store-and-forward indication that is detected by the non-terrestrial core network entity 102 or terrestrial core network entity 103 based on configuration, subscriber information, access management (AM) policy provided to the core network entity 102 or the terrestrial core network entity 103 by a policy control function (PCF) of the core network, or UE location. The store-and-forward indication is stored in the UE context in the core network entity (e.g., AMF) and in the UDM during the registration procedure. This parameter triggers the necessary data buffering functions in the terrestrial core network entity (for MT data) and in the non-terrestrial core network entity (for MO data).

Non-terrestrial core network entity 102 or terrestrial core network entity 103 may use the store-and-forward indication as a trigger to assign longer periodic update timer value to UE 106 to avoid excessively frequent periodic registration updates and possibly also other NAS timer values. Non-terrestrial core network entity 102 or terrestrial core network entity 103 uses the store-and-forward indication as a trigger to assign longer implicit detach timer value to UE 106 in order to avoid implicitly detaching the UE due to long store-and-forward delays.

The store-and-forward indication modifies the core network entity (e.g., AMF-N 102 and AMF-T 103 peers) and the UDM concept of UE reachability. The core network entity and the UDM consider UE 106 to be reachable if the store-and-forward indication indicates that a store-and-forward operation applies for registered UE 106, even if UE 106 is not reachable directly but only via store-and-forward operation.

For MO UPF anchored CP data and NIDD data, while satellite 104 provides coverage for UE 106 and as long as satellite 104 has no connectivity with the ground and the store-and-forward indication indicates that a store-and-forward operation applies for the UE 106, non-terrestrial core network entity 102 receives the MO data from UE 106 and buffers it until satellite 104 travels further on its orbit to reach its next available ground station. Once satellite 104 re-gains ground station connectivity, non-terrestrial core network entity 102 sends the MO data to terrestrial core network entity 103 which may continue the procedure as follows:
For UPF anchored CP data, the terrestrial core network entity 103 (e.g., an AMF-T) continues the procedure as specified in 3GPP TS 23.502 clause 4.24.1 step 4 onwards.
For NIDD data, the terrestrial core network entity 103 (e.g., an AMF-T) continues the procedure as specified in 3GPP TS 23.502 clause 4.25.4 step 1, which refers back to the above clause 4.24.1.

For MT UPF anchored CP data and NIDD data, if UE 106 is not reachable directly and terrestrial core network entity 103 has a store-and-forward indication that indicates that a store-and-forward operation applies for the target UE 106, terrestrial core network entity (e.g., an AMF-T) 103 discovers a non-terrestrial core network entity 102 instance on satellite 104 that is expected to reach the UE later on (e.g., AMF-N). MT data and/or signalling is buffered in the terrestrial core network entity 103, or alternatively, based on terrestrial core network entity103 control re-using existing High Latency communications (HLcom) procedures, in the SMF for an extended buffer duration until terrestrial core network entity gets connectivity with the satellite. terrestrial core network entity103 can then send the MT UPF anchored CP data (dot-dash line) or MT NIDD data (dot-dot-dash line) to non-terrestrial core network entity 102. Non-terrestrial core network entity 102 buffers MT UPF anchored CP data or the MT NIDD data until it can reach target UE 106. When target UE 106 becomes reachable, non-terrestrial core network entity 102 continues to send the MT UPF anchored CP data or the MT NIDD data to UE 106 (dotted lines) as follows:
Non-terrestrial core network entity 102 continues the MT UPF anchored CP data procedure as specified in 3GPP TS 23.502 clause 4.24.2. The procedures to deliver UPF-anchored CP (CIoT) data are specified in TS 23.502 clause 4.24.1 (MO data) and clause 4.24.2 (MT data). UE context in AMF is specified in TS 23.502 clause 5.2.2.2.2;
Non-terrestrial core network entity 102 continues the MT NIDD procedure as specified in 3GPP TS 23.502 clause 4.25.5 step 9.

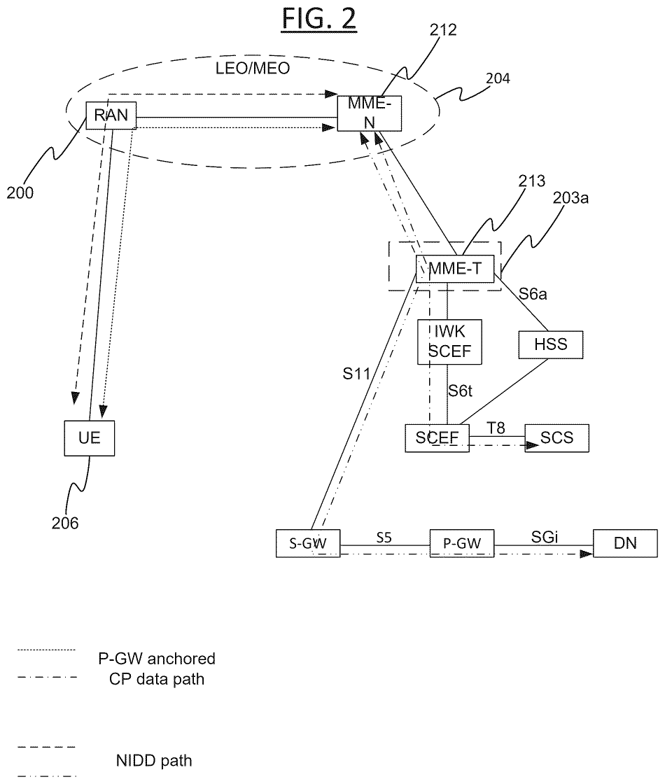

FIG. 2 shows a communications network comprising a RAN node 200 deployed with a non-terrestrial core network entity 212 (e.g., an MME-N) deployed on satellite 204. According to some examples, satellite 204 may have an LEO or MEO. Non-terrestrial core network entity 202 comprises a core network instance on satellite 204. According to some examples, the system architecture of FIG. 2 can be used for P-GW anchored data and/or NIDD. The communications network of FIG. 2 may comprise an EPS network.

A core network instance (e.g., an MME-T) deployed at an apparatus on the ground interfaces with its peer core network instance (e.g., an MME-N 212) deployed on satellite 204. For example, terrestrial core network entity 213 deployed on the ground may have access to satellite orbit data such that terrestrial core network entity 213 is aware of satellite coverage in terms of feeder link availability. Terrestrial core network entity 213 can support the core network entity role (e.g., an MME role) forwards other NFs on the ground. As shown in FIG. 2, other NFs may include IWK Service Capability Exposure Function (IWK-SCEF), Home Subscriber Server (HSS), SCEF, Service Capability Server (SCS), S-GW, P-GW, DN. Terrestrial core network entity 213 can support an interface with satellite specific core network entity (e.g., MME) functionality. The interface may be aware of the delay in transmission of data to/from the terrestrial core network entity 103 and the satellite specific core network entity. Non-terrestrial core network entity 212 on board satellite 204 can select CP data or NIDD and send the CP data or NIDD to UE 206 without having a feeder link at message delivery time, the feeder link comprising the link between non-terrestrial core network entity 212 and terrestrial core network entity 213.

Either of the peer core network entities (e.g., MME-N 212 and/or MME-T 213) and HSS can store a store-and-forward indication in context information for UE 206 when the UE sends an ATTACH request or a TAU update request. Non-terrestrial core network entity 212 can indicate via terrestrial core network entity 213 to HSS that the MME uses store-and-forward operations in communications with the target UE. Terrestrial core network entity 213 can determine the next MME-N that can reach UE 206. Terrestrial core network entity 213 can send CP data or NIDD data towards non-terrestrial core network entity 212 when a feeder link between non-terrestrial core network entity 212 and terrestrial core network entity 213 exists. Non-terrestrial core network entity 212 sends the CP data or NIDD data to UE 206 when UE 206 is in a coverage area of satellite 204.

According to some examples, UE 206 is registered to the network of FIG. 2 when non-terrestrial core network entity 212, terrestrial core network entity 213 and UE 206 are connected. Non-terrestrial core network entity 212 and terrestrial core network entity 213 may detect a need to support store-and-forward operation e.g., during the registration procedure.

According to some examples, non-terrestrial core network entity 212 may have a storage capacity to store the message it transmits between UE 206 and terrestrial core network entity 213. In some examples, non-terrestrial core network entity may have security parameters needed for NAS procedure.

The store-and-forward operation performed at non-terrestrial core network entity 212 or terrestrial core network entity 213 may be steered by the store-and-forward indication that is detected by the non-terrestrial core network entity 212 or terrestrial core network entity 213 (based on configuration, subscriber data, AM policy or location). The store-and-forward indication is stored in the UE's Mobility Management context in the MME and in the HSS during the registration procedure of the UE. This parameter triggers the necessary data buffering functions in the terrestrial core network entity (for MT data) and in the non-terrestrial core network entity for MO data).

Non-terrestrial core network entity 212 or terrestrial core network entity 213 may use the store-and-forward indication as a trigger to assign an extended periodic update timer value to UE 206 to avoid excessively frequent periodic registration updates. Non-terrestrial core network entity 212 or terrestrial core network entity 213 uses the store-and-forward indication as a trigger to assign longer implicit detach timer value to UE 206 in order to avoid implicitly detaching the UE due to long store-and-forward delays.

The store-and-forward indication described herein changes the core network entity (e.g., MME comprises of MME-N 202 and MME-T 203 peers) and the HSS concept of UE reachability. The core network entity and the HSS consider UE 206 to be reachable when the store-and-forward indication indicates that a store-and-forward operation applies for UE 206 and UE 206 is not reachable by a satellite in which the MME-T 203 is deployed.

For MO P-GW anchored CP data and NIDD data, while satellite 204 provides coverage for UE 206 and as long as satellite 204 has no connectivity with the ground station and the store-and-forward indication indicates that a store-and-forward operation applies for UE 206, non-terrestrial core network entity 212 receives the MO data from UE 206 and buffers the MO data until satellite 204 travels further on its orbit to reach it's next available ground station. Once satellite 204 re-gains ground station connectivity, non-terrestrial core network entity 212 sends the MO data to terrestrial core network entity 213 may continue the procedure as follows:
For P-GW anchored CP data, terrestrial core network entity 213 continues the procedure as specified in 3GPP TS 23.401 clause 4.24.1 step 4 onwards. The procedures for MO and MT Data transport in Control Plane CIoT EPS Optimisation with P-GW connectivity are specified in TS 23.401 clause 5.3.4B.
For NIDD data, the terrestrial core network entity 213 continues the procedure as specified in 3GPP TS 23.682 clause 5.13.4 step 1.

For MT P-GW anchored CP data and NIDD data, if UE 206 is not reachable directly and terrestrial core network entity 213 has a store-and-forward indication indicates that a store-and-forward operation applies for the target UE 206, terrestrial core network entity 213 discovers a non-terrestrial core network entity 212 instance on satellite 204 that is expected to reach UE 204 later on (e.g., non-terrestrial core network entity 212). MT data are buffered in the terrestrial core network entity 213, or alternatively, control re-using the existing procedures in the SGW for an extended buffer duration until terrestrial core network entity 213 gets connectivity with satellite 204. Terrestrial core network entity 213 can then send the MT P-GW anchored CP data (dot-dot-dash line) or MT NIDD data (dot-dash line) to non-terrestrial core network entity 212. Non-terrestrial core network entity MME-N 212 buffers MT P-GW anchored CP data or the MT NIDD data until it can reach target UE 206. When target UE 206 becomes reachable, non-terrestrial core network entity 212 continues the procedure by sending the MT P-GW anchored CP data to UE 206 (dotted lines) as follows:
Non-terrestrial core network entity 212 continues the MT P-GW anchored CP data procedure as specified in TS 23.401 clause 5.3.4B.3;
Non-terrestrial core network entity 212 continues the MT NIDD procedure as specified in TS 23.682 clause 5.13.3 step 8.

3GPP TS 36.300 states that for Control Plane CIoT EPS optimisation, as defined in TS 24.301, and Control Plane CIoT 5GS Optimisation, as defined in TS 24.501, A UL NAS signalling message or UL NAS message carrying data can be transmitted in a UL RRC container message, and a DL NAS signalling or DL NAS data can be transmitted in a DL RRC container message. 3GPP TS 36.300 further states that for NB-IoT RRC connection reconfiguration is not supported and AS security is not used.

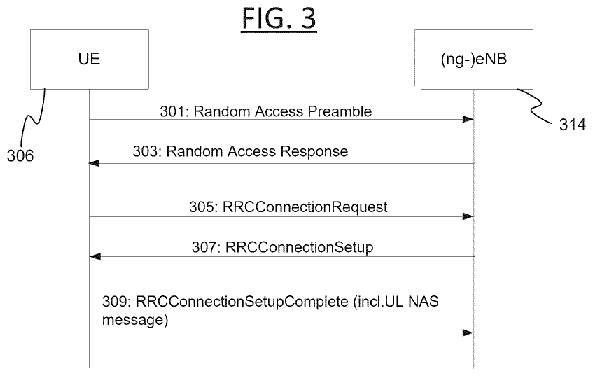

FIG. 3 shows an example message flow for RRC connection establishment procedure for CP CIoT optimisations. The RRC connection establishment procedure may be triggered by a UE 306 when connecting with a RAN node 314 (e.g., eNB of an EPS or a gNB) of a 5GS). At 301, UE 306 sends a Random Access Preamble to RAN node 314. At 303 a Random Access Response is sent from RAN node 314 to UE 306 in response to receipt of the Random Access Preamble. At 305, UE 306 sends an RRC connection request to RAN node 314. At 307 RAN node 314 sends an RRC connection setup message to UE 306 RRC connection request. At 309, UE 306 sends an indication that the RRC connection setup is complete to RAN node 314. The indication sent at 309 may be included in an uplink NAS message that is sent by the UE 306 to the RAN node 314.

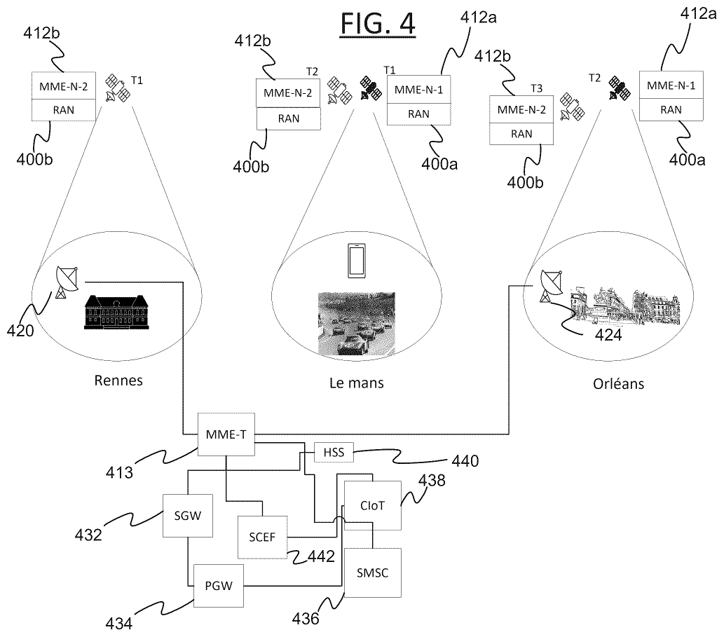

FIG. 4 shows an example of a non-terrestrial network comprising a non-terrestrial network node (e.g., a satellite) and a terrestrial network node during three different time periods. The non-terrestrial network node (e.g., satellite) comprises a non-terrestrial core network entity 412a and a RAN node 400b (illustrated as RAN 400b). It should be noted that the peer core network entities are shown as peer MMEs in FIG. 4, but in other examples the peer core network entities could be peer AMFs in a 5G network or any other suitable peer core network functions.

The terrestrial network node is deployed on the ground and includes a terrestrial core network entity 413, SGW 432, PGW 434, SCEF 442, SMSC 436, CIoT 438, HSS 440.

In the example shown in FIG. 4, there are two non-terrestrial network nodes (e.g., two satellites), shown at different times T1, T2, T3. A first non-terrestrial network node (e.g., a first satellite shown filed in black and solid) includes a first non-terrestrial core network entity (MME-N-1) 412a and a first RAN node 400a (shown as RAN 400a). A non-terrestrial network node (e.g., a second satellite shown in white) includes a second non-terrestrial core network entity (MME-N-2) 412b and a second RAN node 400b (shown as RAN 400b).

In the example of FIG. 4, the first non-terrestrial network node (e.g., the first satellite) has ground station connectivity when located in Rennes (e.g., connectivity with ground station 420 located in Rennes when ground station 420 is within a coverage area of the first non-terrestrial network node) and ground station connectivity when located in Orleans (e.g., connectivity with ground station 424 located in Orleans when ground station 424 is within a coverage area of the first non-terrestrial network node), but no ground station connectivity when crossing (e.g., passing over) Le Mans The second non-terrestrial network node (e.g., the second satellite) has ground station connectivity when located in Rennes (e.g., connectivity with ground station 420 located in Rennes when ground station 420 is within a coverage area of the second non-terrestrial network node) and ground station connectivity when located in Orleans (e.g., connectivity with ground station 424 located in Orleans when ground station 424 is within a coverage area of the second non-terrestrial network node), but no ground station connectivity when crossing (e.g., passing over) Le Mans. For illustration, T1 is between 10.00-10.20 and T2 is between 10.40-11.00.

At time T1, the first non-terrestrial network node (e.g., the first satellite) comprising the first non-terrestrial core network entity (MME-N-1) 412a and the first RAN node 400a is covering (e.g. located over) Le Mans and the second non-terrestrial network node (e.g., the second satellite) comprising the second non-terrestrial core network entity (MME-N-2) 412b and RAN node 400b is providing coverage to Rennes (e.g., is located over Rennes and has ground station connectivity). At T2, the first non-terrestrial network node (e.g., the first satellite shown in black) will be providing coverage to Orleans (e.g., will be located be over and have ground station connectivity) and the second non-terrestrial network node (e.g., the second satellite) will be covering Le Mans. At time T3, the second non-terrestrial network node (e.g., the second) satellite will have ground station connectivity with Orleans (e.g., will establish connectivity with ground station 424 located in Orleans) and sync up with the terrestrial core network entity (MME-T) 413 of the terrestrial network node.

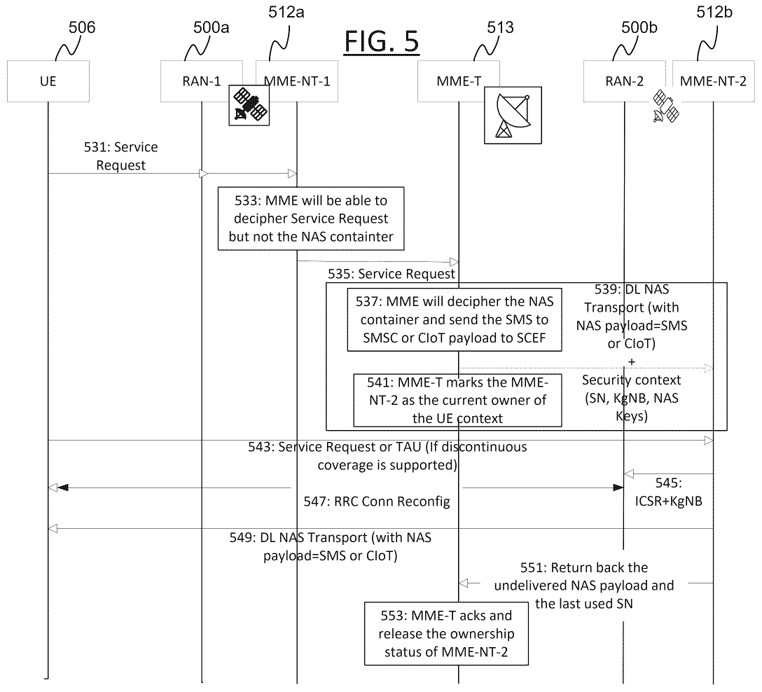

FIG. 5 shows an example of signalling and operations that occur when a UE requests a service provided by a NTN that is configured for store and forward operations. The NTN includes a first RAN node (RAN-1) 500a and a first non-terrestrial core network entity (MME-NT-1 512a) deployed at a first satellite, a second RAN node (RAN-2) 500b, a second non-terrestrial core network entity (MME-NT-2) 512b deployed at a second satellite, and a third MME (MME-T) 513 deployed at a ground station. In the example of FIG. 5 the UE context of UE 506 may comprise a store-and-forward indication that indicates that store and forward operations apply for the UE 506. The time periods T1, T2 and T3 discussed above with respect to FIG. 4 and the positions of the first RAN node (RAN-1) 500a and the first non-terrestrial core network entity (MME-NT-1) 512a at T1, T2 and T3, as well as the positions of the second RAN (RAN-2) 500b and the second non-terrestrial core network entity (MME-NT-2) 512b at T1, T2 and T3 discussed with respect to FIG. 4 apply to the example shown in FIG. 5. It should be noted that the peer core network entities are shown as peer MMEs in FIG. 5, but in other examples the peer core network entities could be peer AMFs in a 5G network or any other suitable network.

At 531, UE 506 sends a service request to the first RAN node (RAN-1) 500a. The service request may be forwarded by the first RAN (RAN-1) 500a to the first non-terrestrial core network entity (MME-NT-1 512a). According to some examples, the service request may be included in a NAS container of a NAS UL Transport message and the NAS UL Transport message may be included in an RRC message that is sent to the first RAN node (RAN-1) 500. The RRC message may be or comprise clear text and the NAS UL Transport message may be partially clear text and the NAS container is secured with security context already received by the UE 106 when the UE 106 registered with the NTN. The NAS container may contain CIoT data or NAS-SMS data.

At 533, the first non-terrestrial core network entity (MME-NT-1) 512a will be able to decipher the service request but not the NAS container. Hence, the first non-terrestrial core network entity (MME-NT-2) 512a checks the message type of the NAS message and determines that the message type is initial message (i.e., a service request). The first non-terrestrial core network entity (MME-NT-2) is not able to decipher NAS container at 533 because, in this example, the first non-terrestrial core network entity (MME-NT-1) 512a does not have a security context for the UE 106. The first non-terrestrial core network entity (MME-NT-1) 512a stores the NAS container until T2 (until the first non-terrestrial core network entity (MME-NT-1) 512a reaches Orleans).

At 535, at T2 when the first non-terrestrial core network entity (MME-NT-1) 512a reaches Orleans, the first non-terrestrial core network entity (MME-NT-1) 512a forwards the NAS container (or the service request along with the NAS container) to the terrestrial core network entity (MME-T) 513. At 537, terrestrial core network entity (MME-T) 513 having the security context for UE 506 will decipher the NAS container. If the NAS container comprises CIoT data, terrestrial core network entity (MME-T) 513 will forward the NAS container (e.g., the NAS payload of the NAS container which contains CIoT data) to SCEF. If the NAS container comprises NAS-SMS data, terrestrial core network entity (MME-T) 513 forwards the NAS container (e.g., the NAS payload of the NAS container which contains NAS-SMS data) to SMSC.

At 539, if terrestrial core network entity (MME-T) 513 receives an SMS acknowledgement or any DL NAS Transport message comprising a NAS payload with CIoT data or NAS-SMS data for UE 506, terrestrial core network entity (MME-T) 513 will send the SMS acknowledgement or any DL NAS Transport message for UE 506 in plain text to the second non-terrestrial core network entity (MME-NT-2) 512b which at this time is located over Rennes with connectivity to the ground station 420 (time T3). The terrestrial core network entity (MME-T) 513 provides the security context for UE 106 along with SN number to the second non-terrestrial core network entity (MME-N-2) 512b. According to some examples, at 539, terrestrial core network entity (MME-T) 513 also provides the security key for the gBN (denoted as (KgNB)) and NAS keys for UE 506. At 541, terrestrial core network entity (MME-T) 513 marks the second non-terrestrial core network entity (MME-NT-2) 512b as the owner of the UE context of UE 506.

At 543, UE 506 may send a service request or TAU to the second non-terrestrial core network entity (MME-NT-2) 512b. In some examples, this is sent when discontinuous coverage is supported by UE 506 and/or the second non-terrestrial network (MME-NT-2) 512b.

At 545, the second non-terrestrial core network entity (MME-NT-2) 512b may send an Initial Context Setup Request (ICSR) and KgNB for UE 506 to the second node (RAN-2) 500b. At 547, the second (RAN-2) 500b sends an RRC connection reconfiguration to UE 506. At 549, the second non-terrestrial core network entity (MME-NT-2) 512b may send a DL NAS transport after successfully establishing the RRC via a service request procedure or via a network-initiated paging. At 549, a DL NAS transport message (with NAS payload comprising NAS-SMS data or CIoT data, for example) is sent from the second non-terrestrial core network entity (MME-NT-2) 512b to UE 506.

After receiving the receiving security context along with current SN, the second non-terrestrial core network entity (MME-NT-2) 512b may cipher and integrity protect the NAS payload. The NAS payload may then be sent in a DownLink (DL) NAS transport message to UE 506. The NAS payload may comprise SMS or CIoT data.

At 551, at T3 the second non-terrestrial core network entity (MME-NT-2) 512b sends back (e.g., returns) the undelivered NAS payload and the last used SN to terrestrial core network entity (MME-T) 513. After serving the UE 506 and sending DL transport messages, the second non-terrestrial core network entity (MME-NT-2) 512b upon regaining the ground connectivity at Orleans reports to terrestrial core network entity (MME-T) 513 on the delivery status and active security context (including current SN). The second non-terrestrial core network entity (MME-N-2) 512a syncs its own security context and releases it's the second ownership of non-terrestrial core network entity (MME-NT-2) 512b from the UE context of UE 506.

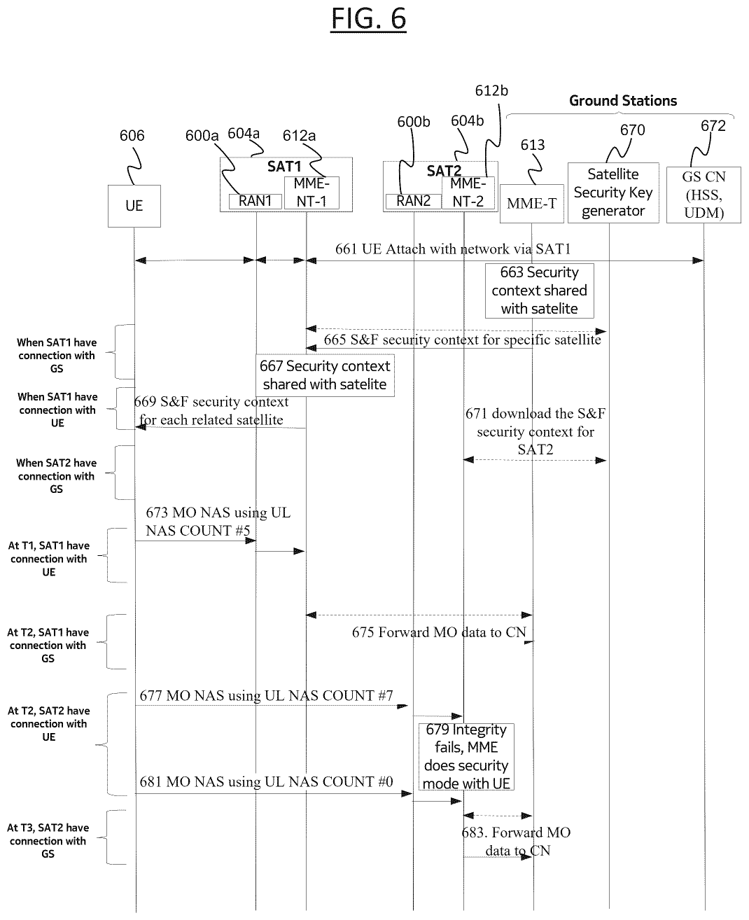

FIG. 6 shows an example of signalling and operations that occur when a UE attaches to an NTN that is configured for store and forward operations. The NTN shown in FIG. 6 includes a first satellite 604a comprising a first RAN node (illustrated as RAN1) 600a and a first non-terrestrial core network entity (MME-NT-1) 612a, a second satellite 604b comprising a second RAN node (illustrated as RAN 2) 600b and a second non-terrestrial core network entity (MME-NT-2) 612b, a ground station comprising a terrestrial core network entity 613, a satellite security key generator 670 and other terrestrial core network entities 672 (e.g., HSS, UDM). It should be noted that the peer core network entities are shown as peer MMEs in FIG. 6, but in other examples the peer core network entities could be peer AMFs in a 5G network or any other suitable network.

The time periods T1, T2 and T3 discussed above with respect to FIG. 4 and the positions of the first RAN node (RAN-1) and the first non-terrestrial core network entity (MME-NT-1) at T1, T2 and T3, as well as the positions of the second RAN node (RAN 2) 600b and the second non-terrestrial core network entity (MME-NT-2) 612b at T1, T2 and T3 discussed with respect to FIG. 4 may apply to the example of FIG. 6.

At 661, UE attaches with the NTN via satellite 604a. During attachment of the UE 606 with the NTN, at 663 terrestrial core network entity 613 can ensure authentication is successful and that NAS keys are available to terrestrial core network entity (MME-T) 613 for UE 606.

At 665 to 671, terrestrial core network entity (MME-T) 613 evaluates and re-evaluates which satellite has ground station connectivity, and shares the NAS keys for UE 606 with the satellite that does have ground station connectivity.

At 665, the first satellite 604a has connection with a ground station (GS) (e.g., with terrestrial core network entity (MME-T) 613). The UE context of UE 606 comprising security information and a store-and-forward indication for UE 606 is sent from terrestrial core network entity (MME-T) 613 to the first non-terrestrial core network entity (MME NT-1) 612a. At 667, the UE context of UE 606 is shared by the first non-terrestrial core network entity (MME-NT-1) 612a with the satellite 604a.

At 669, the first satellite 604a has a connection with UE 606 (e.g., UE connectivity with UE 606) and the store-and-forward security context for each “related” satellite is shared with UE 606. In some examples, a “related” satellite for UE 606 may comprise a satellite which is likely to serve UE 606 in the future. In some examples, a “related” satellite for UE 606 may comprise a satellite that is authenticated and/or authorized to serve UE 606.

At 671, the second satellite 604b has a connection with the ground station (e.g., terrestrial core network entity (MME-T) 613). The store-and-forward security context for the second satellite 604b can be downloaded from the satellite security key generator 670.

At 673 (T1), the first satellite 604a have a connection with UE 606. MO data from UE 606 can be sent to the first RAN node (RAN1) 600a using the initial NAS encryption and NAS count from 669.

At 675 (T2), the first satellite 604a has a connection with UE 606. MO data can be forward from the first non-terrestrial core network entity (MME-NT-1) 612a to the second non-terrestrial core network entity (MME-NT-2) 612b.

At 677 (T2), the second satellite 604b has a connection with UE 606. MO data from UE 606 can be sent to the second RAN (RAN2) 600b using the NAS encryption and NAS count from 673.

At 679, the situation where NAS integrity fails is considered. If NAS integrity fails at any non-terrestrial core network entity (e.g., MME-NT-1 612a or MME-NT-2 612b), the terrestrial core network entity (MME-T) 613 performs a security mode procedure to share its security keys with UE 606. During the security mode procedure, the terrestrial core network entity (MME-T) 613 may enable NAS security by exchanging ciphering and integrity keys with UE 606. At 681, upon receiving the NAS security mode command, UE 606 resets its UL NAS count. The second non-terrestrial core network entity (MME-NT-2) 612b resets its DL NAS COUNT upon completion of the security mode procedure. Any message sent after the security mode procedure, shall be ciphered and integrity protected in each direction.

At 683, the second satellite 604b has a connection with the ground station, and forwards MO data to terrestrial core network entity (MME-T) 613.

In FIG. 6, if any non-terrestrial core network entity (e.g., the first non-terrestrial core network entity (MME-NT-1) 612a and/or the second non-terrestrial core network entity (MME-NT-2) 612b receives initial UE message does not have security context for the UE 606, the non-terrestrial core network entity assumes the UE is unauthenticated.

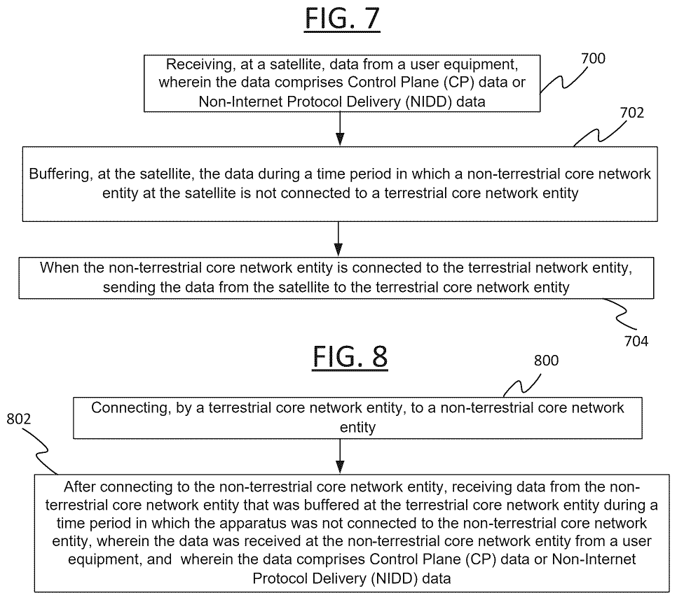

FIG. 7 shows an example method performed by a non-terrestrial core network entity (e.g., AMF-N or MME-N).

At 700, the method comprises receiving at a satellite, data from a user equipment, wherein the data comprises CP data or NIDD data.

At 702, the method comprises buffering, at the satellite, the data during a time period in which a non-terrestrial core network entity at the satellite is not connected to a terrestrial core network entity.

At 704, the method comprises sending, while the non-terrestrial core network entity is connected to the terrestrial network entity, the data from the satellite to the terrestrial core network entity.

FIG. 8 shows an example performed by a terrestrial core network entity (e.g., AMF-T or MME-T).

At 800, the method comprises connecting, by a terrestrial core network entity, to a non-terrestrial core network entity.

At 802, the method comprises after connecting to the non-terrestrial core network entity, receiving data from the non-terrestrial core network entity that was buffered at the terrestrial core network entity during a time period in which the apparatus was not connected to the non-terrestrial core network entity, wherein the data was received at the non-terrestrial core network entity from a user equipment, and wherein the data comprises CP data or NIDD data

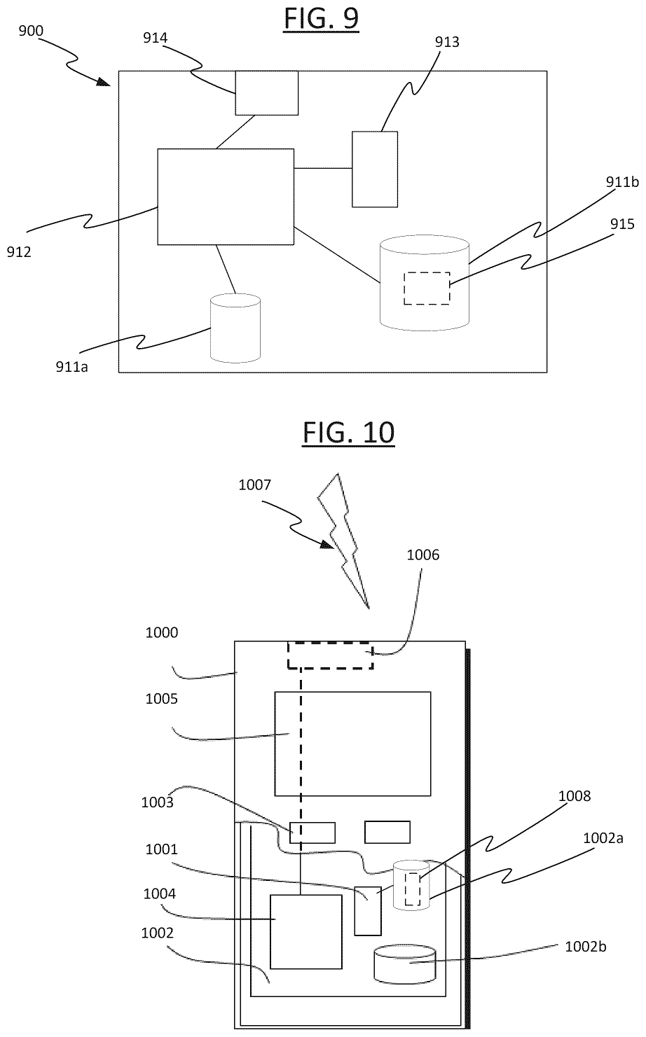

FIG. 9 illustrates an example of a core network entity, for example a non-terrestrial core network entity (e.g., MME-NT or AMF-NT) or a terrestrial core network entity (e.g., MME-T or AMF-T) illustrated in FIG. 1 and/or FIG. 2. The core network entity 900 may comprise at least one random access memory (RAM) 911a, at least one read only memory (ROM) 911b, at least one processor 912, 913 and a network interface 914. The at least one processor 912, 913 may be coupled to the RAM 911a and the ROM 911b. The at least one processor 912, 913 may be configured to execute software code 915 or may execute instructions of software code 915. Execution of the software code 915 (or execution of instructions of software code 915) may for example may cause the core network entity to perform operations. For example, when the core network entity is a non-terrestrial core network entity ((e.g., MME-NT or AMF-NT) execution of the software code 915 (or execution of instructions of the software code 915) causes the non-terrestrial core network entity to perform the method shown in FIG. 7 and described herein. When the core network entity is a terrestrial core network entity (MME-T or AMF-T), execution of the software code 915 (or execution of the instructions of the software code 915) cases the terrestrial core network entity to perform the method shown in FIG. 8 and described herein. The software code 915 may be stored in the ROM 911b. The apparatus 900 may be interconnected with another apparatus 900 comprising or implementing other network functions of the 5GC. In some embodiments, the apparatus is deployed at a ground station and the software code 915 is software code (e.g., MME-N or AMF-N). In some embodiments, the apparatus is deployed at a satellite and comprises or implements one network function (e.g., MME-T or AMF-T). In alternative embodiments, the apparatus 900 may comprises or implements two or more network functions.

FIG. 10 illustrates an example of a communication device 1000, such as the UE 106 illustrated in FIG. 1 or UE 206 illustrated in FIG. 2. Non-limiting examples of a communication device 1000 comprise a user equipment (e.g., UE 106, 206), a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The communication device 1000 may comprise a transceiver for transmitting and/or receiving, for example, wireless signals carrying communications, for example radio signals. The communications may be one or more of voice, electronic mail (email), text messages, multimedia data, machine data and so on.

The communication device 1000 may receive wireless signals (e.g., radio signals) over an air or radio interface 1007 via appropriate apparatus for receiving and may transmit wireless signals via appropriate apparatus for transmitting radio signals. In FIG. 10, the apparatus is designated schematically by block 1006. The apparatus 1006 may comprise, for example, a radio part, associated antenna arrangement, and the transceiver. The antenna arrangement may be arranged internally or externally to the mobile device and may comprise one or more antenna elements. The antenna arrangement may be a multi-input multi output (MIMO) antenna.

The communication device 1000 may be provided with or includes at least one processor 1001, at least one memory ROM 1002a, at least one RAM 1002b and other possible components 1003 for use in software and hardware aided execution of tasks it is designed to perform, including control of access to and communications with access node (e.g., RAN nodes 400a, 400b, 500a, 500b) and other communication devices. The at least one processor 1001 is coupled to the RAM 1002b and the ROM 1002a. The at least one processor 1001 may be configured to execute an appropriate software code 1008. The software code 1008 may for example allow to perform one or more operations of the communication device. The software code 1008 may be stored in the ROM 1002a.

The processor, the ROM, and the RAM, the transceiver and other circuitry of the communication device (e.g., a modem) can be provided on a circuit board, in chipsets, or in a system on chip. The circuit board, chipsets or system on chip is denoted by reference 1004. The communication device 1000 may optionally have a user interface such as keypad 1005, touch sensitive screen or pad, combinations thereof or the like. Optionally one or more of a display, a speaker and a microphone may be provided depending on the type of communication device.

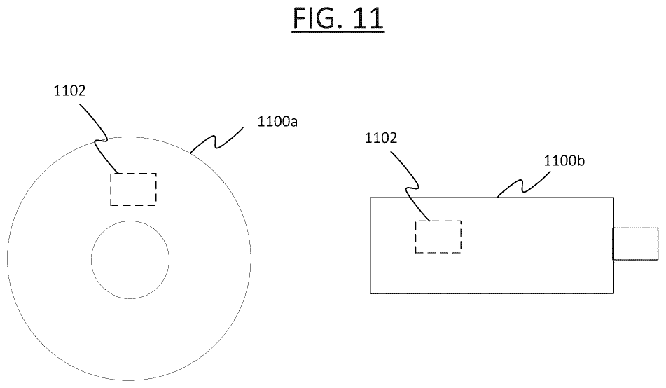

FIG. 11 shows a schematic representation of non-volatile memory media 1100a (e.g. computer disc (CD) or digital versatile disc (DVD)) and 1100b (e.g. universal serial bus (USB) memory stick) storing instructions and/or parameters 1102 which when executed by a processor allow the processor to perform one or more of the steps of any method flow described herein.

It is understood that references in the above to various network functions (e.g., to an AMF, an SMF, TNF etc.) may comprise apparatus that perform at least some of the functionality associated with those network functions. Further, an apparatus comprising a network function may comprise a virtual network function instance of that network function.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used herein, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of the term “means” herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASIC), FPGA, gate level circuits and processors based on multi core processor architecture, as non-limiting examples.

Various example embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various example embodiments of the disclosure is set out by the independent claims. The example embodiments and features thereof, if any, described in this disclosure that do not fall under the scope of the independent claims are to be interpreted as examples useful for understanding various example embodiments of the disclosure.

The foregoing description has provided, by way of non-limiting and illustrative examples, a full and informative description of the various example embodiments of this disclosure. However, various modifications and adaptations may become apparent to those skilled in the relevant arts in view of the foregoing description, when read in conjunction with the accompanying drawings and the claims. However, all such and similar modifications of the teachings will still fall within the various example embodiments of the disclosure as set forth in the claims. By way of non-limiting and illustrative example, there is a further example embodiment comprising a combination of one or more example embodiments with any of the other example embodiments previously discussed.

We claim:

1. A non-terrestrial core network entity for a communication network, the non-terrestrial core network entity comprising:
at least one processor; and
at least one memory storing instructions which, when executed by the terrestrial core network entity, cause the terrestrial core network entity to perform operations, the operations comprising at least:
receiving data from a user equipment, wherein the data comprises Control Plane (CP) data or Non-Internet Protocol Delivery (NIDD) data; and
buffering the data during a time period in which the non-terrestrial core network entity is not connected to a terrestrial core network entity; when the non-terrestrial core network entity is connected to the terrestrial network entity, sending the data to the terrestrial core network entity.

2. The non-terrestrial core network entity according to claim 1, wherein the buffering comprises:
buffering the data when user equipment context for the user equipment comprises an indication that the non-terrestrial core network entity is to store and forward data received from the user equipment.

3. The non-terrestrial core network entity according to claim 2, wherein the operations further comprise:
detecting the indication based on at least one of configuration of the non-terrestrial core network entity, subscriber information for a subscriber associated with the equipment, location information for the apparatus and an access and mobility policy; and
storing, at the non-terrestrial core network entity, the indication in the user equipment context.

4. The non-terrestrial core network entity according to claim 2, wherein the operations further comprise:
determining a periodic update timer value for the user equipment for at least one of a periodic registration update and a tracking area update, wherein when the indication is present in the context information for the user equipment, the periodic update timer value is increased relative to when the indication is not present in the context information for the user equipment.

5. The non-terrestrial core network entity according to claim 2, wherein the operations further comprise:
determining a user equipment reachability of the user equipment based on the presence of the indication in the user equipment context, wherein when the indication is present in the user equipment context the user equipment is determined as reachable via a store-and-forward operation.

6. The non-terrestrial core network entity according to claim 2, wherein the operations further comprise:
determining a timer value for the user equipment for detaching from a network when not connected to the terrestrial network function, wherein when the indication is present in the context information for the user equipment, the timer value is increased relative to when the indication is not present in the context information for the user equipment.

7. The non-terrestrial core network entity according to claim 1, wherein the operations further comprise:
sending, in response to receiving the data from the user equipment, an acknowledgement message to the user equipment, wherein the acknowledgement message comprises a Non-Access-Stratum protocol message.

8. The non-terrestrial core network entity according to claim 1, wherein the data sent to the terrestrial core network entity is secured in a Non-Access-Stratum container, wherein the terrestrial core network entity is configured to decipher the Non-Access-Stratum container using a security context of the user equipment.

9. The non-terrestrial core network entity according to claim 1, wherein the non-terrestrial core network entity comprises an access and mobility management function (AMF) and the terrestrial core network entity comprises an AMF.

10. The non-terrestrial core network entity according to claim 1, wherein the non-terrestrial core network entity comprises a Mobility Management Entity (MME) and the terrestrial core network entity comprises an MME.

11. A terrestrial core network entity for a non-terrestrial network of a communication network, the terrestrial core network entity comprising:
at least one processor; and
at least one memory storing instructions which, when executed by the terrestrial core network entity, cause the terrestrial core network entity to perform operations, the operations comprising at least:
connecting to a non-terrestrial core network entity; and
after connecting to the non-terrestrial core network entity, receiving data from the non-terrestrial core network entity that was buffered at the non-terrestrial core network entity during a time period in which the terrestrial core network entity was not connected to the non-terrestrial core network entity, wherein the data was received at the non-terrestrial core network entity from a user equipment, and wherein the data comprises Control Plane (CP) data or Non-Internet Protocol Delivery (NIDD) data.
connecting to a non-terrestrial core network entity; and
after connecting to the non-terrestrial core network entity, receiving data from the non-terrestrial core network entity that was buffered at the non-terrestrial core network entity during a time period in which the terrestrial core network entity was not connected to the non-terrestrial core network entity, wherein the data was received at the non-terrestrial core network entity from a user equipment, and wherein the data comprises Control Plane (CP) data or Non-Internet Protocol Delivery (NIDD) data.

12. The terrestrial core network entity according to claim 11, wherein the operations further comprise:
receiving, from a network entity and at a first time, second data for sending to the user equipment;
determining that a second non-terrestrial core network entity will be configured to connect to the user equipment and the terrestrial core network entity at a second time, wherein the second time is after the first time;
buffering the second data at the terrestrial core network entity until the second time; and
at or after the second time and while the second non-terrestrial core network entity is connected to the user equipment and the terrestrial core network entity, sending the second data to the second non-terrestrial core network entity.

13. The terrestrial core network entity according to claim 12, wherein the buffering comprises:
buffering the second data when an indication is present in a user equipment context for the user equipment.

14. The terrestrial core network entity according to claim 13, wherein the operations further comprise:
detecting the indication based on at least one of configuration of the terrestrial core network entity, subscriber information for the terrestrial core network entity, location information for the terrestrial core network entity and an access and mobility policy for the terrestrial core network entity; and
storing the indication in the user equipment context for the user equipment.

15. The terrestrial core network entity according to claim 13, wherein the operations further comprise:
determining a periodic update timer value for the user equipment for at least one of a periodic registration update and a tracking area update, wherein when the indication is present in the user equipment context for the user equipment, the periodic update timer value is increased relative to when the indication is not present in the context information for the user equipment.

16. The terrestrial core network entity according to claim 12, wherein the operations further comprise:
determining a timer value for the user equipment for detaching from a network when not connected to the terrestrial core network entity, wherein when the indication is present in the context information for the user equipment, the timer value is increased relative to when the indication is not present in the context information for the user equipment.

17. The terrestrial core network entity according to claim 16, wherein the data received from the non-terrestrial core network entity deployed is secured in a Non-Access-Stratum container, and wherein the means is further for:
deciphering the Non-Access-Stratum container using a security context of the user equipment to determine a payload of the Non-Access-Stratum container.

18. The terrestrial core network entity according to claim 17, wherein the operations comprise further comprise:
sending the payload to a third the non-terrestrial core network entity with connectivity to the terrestrial core network entity.

19. The terrestrial core network entity according to claim 11, wherein the non-terrestrial core network entity comprises an access and mobility management function (AMF) and the terrestrial core network entity comprises an AMF.

20. The terrestrial core network entity according to claim 11, wherein the non-terrestrial core network entity comprises a Mobility Management Entity (MME) and the terrestrial core network entity comprises an MME.

21. A method for a terrestrial core network entity, the method comprising:
connecting to a non-terrestrial core network entity; and
after connecting to the non-terrestrial core network entity, receiving data from the non-terrestrial core network entity that was buffered at the non-terrestrial core network entity during a time period in which the terrestrial core network entity was not connected to the non-terrestrial core network entity, wherein the data was received at the non-terrestrial core network entity from a user equipment, and wherein the data comprises Control Plane (CP) data or Non-Internet Protocol Delivery (NIDD) data.
